(19) United States
(12) Patent Application Publication
(10) Pub. No.: US 2016/0164317 A1
(43) Pub. Date: Jun. 9, 2016

(54) BATTERY MONITORING METHOD AND APPARATUS FOR PERFORMING THE SAME

(71) Applicant: HYUNDAI AUTRON CO., LTD., Seongnam-si (KR)

(72) Inventors: Sang-Ho LEE, Suwon-si (KR); Hee-Hyun LEE, Yongin-si (KR)

(21) Appl. No.: 14/958,451

(22) Filed: Dec. 3, 2015

(30) Foreign Application Priority Data
Dec. 5, 2014 (KR) 10-2014-0174271

(51) Int. Cl. H02J 7/00

(52) U.S. Cl. CPC H02J 7/0021; H02J 7/0014

(57) ABSTRACT

A battery monitoring apparatus according to an embodiment of the present invention includes: a summation processing unit that calculates a voltage for multiple cells including single cells selected from a plurality of single cells of a battery; a monitoring unit that monitors at least one of voltages for single cells of the battery and a voltage for the multiple cells of the battery; and a control unit that identifies whether the battery is normal by using the at least one of the voltages for the single cells of the battery and the voltage for the multiple cells of the battery.

### CROSS-REFERENCE TO RELATED APPLICATIONS

This application claims the priority of Korean Patent Application No. KR 10-2014-0174271 filed on Dec. 5, 2014, in the Korean Intellectual Property Office, the disclosure of which is incorporated herein by reference.

### BACKGROUND

1. Technical Field

The present invention relates to a battery monitoring method and an apparatus for performing the same.

2. Description of the Related Art

Vehicles that mainly use gasoline or heavy oil seriously influence pollutions such as atmospheric contaminations. Accordingly, in recent years, a lot of efforts have been made to improve electric vehicles to reduce pollutions.

The electric vehicles use a battery engine that is operated by electrical energy output from a battery. The electric vehicles uses a battery in which a plurality of rechargeable secondary cells form one pack as a main power source, and thus does not emit exhaust gases at all and generates little noise.

In this way, because the performance of a battery directly influences the performance of the electric vehicle, the performance of the battery cells should be excellent, and a battery monitoring system that may measure the voltages of the battery cells and the voltage and current of the entire battery to efficiently manage charging/discharging operations of the battery cells are being urgently required.

The battery monitoring system should correct a voltage unbalance such that the voltages of the battery cells fall within a preset reference voltage range.

For example, a voltage unbalance from other battery cells is corrected by solving an overcharging problem by discharging the battery after an overcharged battery cell is searched for. The correction of the voltage unbalance is called cell balancing.

A battery monitoring system will be described with reference to FIG. 1. The battery monitoring system includes a battery 10 and a battery monitoring unit 20.

The battery 10 includes a sub-pack including a plurality of battery cells. For example, the battery 10 may include a sub-pack including N battery cells.

The battery monitoring unit 20 sequentially calculates the voltages of cells of the battery 10, and identifies whether the cells of the battery 10 is normal by identifying whether the voltages of the cells of the battery 10 fall within a preset reference voltage range.

As illustrated in FIG. 1, the battery monitoring unit 20 calculates the voltage of No. 1 cell 11 of the cells of the battery 10, and identifies whether No. 1 cell 11 is normal by identifying whether the voltage of the No. 1 cell 11 falls within the preset reference voltage range.

Thereafter, the battery monitoring unit 20 calculates the voltage of No. 2 cell 12 of the cells of the battery 10, and identifies whether No. 2 cell 12 is normal by identifying whether the voltage of the No. 1 cell 12 falls within the preset reference voltage range.

Next, the battery monitoring unit 20 calculates the voltage of No. 3 cell 13 of the cells of the battery 10, and identifies whether No. 3 cell 13 is normal by identifying whether the voltage of the No. 1 cell 13 falls within the preset reference voltage range.

As mentioned above, the battery monitoring unit 20 calculates the voltages of the N cells of the battery 10, and identifies whether the cells are normal by identifying the voltages of the cells fall within the preset reference voltage range.

The battery monitoring unit 20 repeats the above process N times corresponding to the total number of the battery cells, and when the battery 10 is repeatedly monitored to improve preciseness, the above process should be repeated (the number of repetition)×N times.

Currents are consumed in the process of calculating and monitoring the voltages of the cells of the battery 10 by the battery monitoring unit 20. However, because the battery monitoring is not driving of the electric vehicle that is the main purpose of the battery cells, it may be considered ideal when the amount of the currents consumed due to the battery monitoring is small.

However, as illustrated in FIG. 1, if the voltages of the cells of the battery 10 are sequentially calculated and monitored, there is a limit by which currents are consumed to manage the battery to shorten the life space of the battery even at an initial stage when it is unnecessary to control the battery.

### SUMMARY

Therefore, the present invention provides a battery monitoring method in which, by monitoring a battery using a voltage for multiple cells of the battery, current consumption for the purpose of managing the battery can be minimized by promptly terminating monitoring of a corresponding cell at an initial stage where it is unnecessary to control the battery, and an apparatus for performing the method.

The present invention also provides a battery monitoring method in which a battery is monitored to be efficiently managed by selecting any one voltage of a voltage for multiple cells of a battery and voltages for single cells of the battery according to a state of the battery, and an apparatus for performing the method.

The objects of the present invention are not limited to the above-mentioned ones, and other objects will be made clear to those skilled in the art from the following description.

In accordance with an aspect of the present invention, there is provided a battery monitoring apparatus including: a summation processing unit that calculates a voltage for multiple cells including single cells selected from a plurality of single cells of a battery; a monitoring unit that monitors at least one of voltages for single cells of the battery and a voltage for the multiple cells of the battery; and a control unit that identifies whether the battery is normal by using the at least one of the voltages for the single cells of the battery and the voltage for the multiple cells of the battery.

In an embodiment, the control unit may determine whether the at least one of the voltages for the single cells of the battery and the voltage for the multiple cells of the battery falls within a preset reference voltage range.

In an embodiment, if the voltage for the multiple cells of the battery does not fall within the preset reference voltage range, the control unit may control the summation processing unit such that a voltage for some cells of the multiple cells of the battery is calculated.

In an embodiment, if the voltage for the multiple cells of the battery falls within the preset reference voltage range, the control unit may determine that the corresponding cells are normally operated.

In an embodiment, if the some cells correspond to a single cell, the control unit may determine whether a voltage for the single cell of the battery falls within a preset reference voltage range.

In an embodiment, if the voltage for the single cell of the battery does not fall within the preset reference voltage range, the control unit may execute balancing for the corresponding cell.

In an embodiment, the monitoring unit may include: a MUX that receives at least one of voltages for single cells of the battery and a voltage for the multiple cells of the battery; and an A/D converter that, if receiving at least one of the voltages of the single cells of the battery and the voltage for the multiple cells of the battery, converts the received at least one voltage to a digital voltage and provides the digital voltage for the control unit.

In an embodiment, the summation processing unit may include: a first MUX that is located an positive electrode at an upper end of the multiple cells to calculate a first voltage for the multiple cells; a second MUX that is located an negative electrode at a lower end of the multiple cells to calculate a first voltage for the multiple cells; a first resistance distribution module that adjusts the first voltage calculated by the first MUX; a second resistance distribution module that adjusts the second voltage calculated by the second MUX; and a level shift amplifier that outputs a voltage for multiple cells by using the first voltage received from the first resistance distribution module and the second voltage received from the second resistance distribution module.

In accordance with another aspect of the present invention, there is provided a battery monitoring method executed by a battery monitoring apparatus that monitors a voltage of a battery, the battery monitoring method including: calculating a voltage of multiple cells of the battery; determining whether the voltage for the multiple cells falls within a preset reference voltage range; and identifying whether the battery is normal according to the determination result.

In an embodiment, determining whether the voltage for the multiple cells falls within a preset reference voltage range may include: if the voltage for the multiple cells does not fall within the preset reference voltage range, calculating a voltage for some cells of the multiple cells of the battery; and determining whether the voltage for the some cells falls within a preset reference voltage range.

In an embodiment, determining whether the voltage for the multiple cells falls within a preset reference voltage range may include: if the voltage for the multiple cells falls within the preset reference voltage range, determining that the corresponding cells are normally operated.

In an embodiment, calculating a voltage of multiple cells of the battery may include: if the some cells correspond to a single cell, determining whether a voltage for the single cell of the battery falls within a preset reference voltage range.

In an embodiment, determining whether the voltage for the single cell falls within a preset reference voltage range may include: if the voltage for the single cell of the battery does not fall within the preset reference voltage range, executing balancing for the corresponding cell.

Detailed items of the other embodiments are included in the detailed description and the accompanying drawings.

The above and other aspects, features and advantages of the invention will become apparent from the following description of the following embodiments given in conjunction with the accompanying drawings. However, the present invention is not limited to the embodiments disclosed below, and may be implemented in various forms. The embodiments of the present invention is provided to make the disclosure of the present invention complete and fully inform those skilled in the art to which the present invention pertains of the scope of the present invention. The same reference numerals denote the same elements throughout the specification.

According to the present invention, by monitoring a battery using a voltage for multiple cells of the battery, current consumption for the purpose of managing the battery can be minimized by promptly terminating monitoring of a corresponding cell at an initial stage where it is unnecessary to control the battery, and an apparatus for performing the method.

Furthermore, according to the present invention, a battery can be monitored to be efficiently managed by selecting any one voltage of a voltage for multiple cells of a battery and voltages for single cells of the battery according to a state of the battery, and an apparatus for performing the method.

### BRIEF DESCRIPTION OF THE DRAWINGS

FIG. 1 is a block diagram illustrating a battery monitoring system;

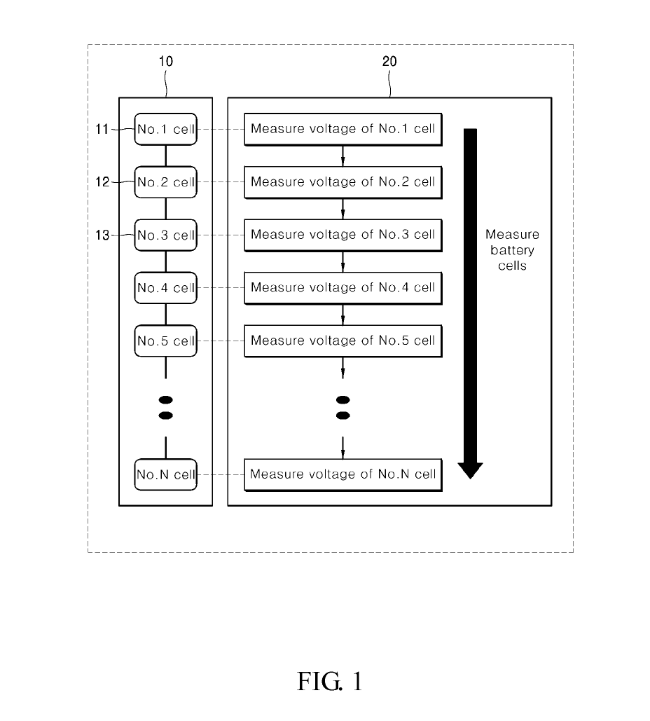

FIG. 2 is a block diagram illustrating a battery monitoring system according to an embodiment of the present invention;

FIG. 3 is a block diagram illustrating an internal structure of a summation processing unit of FIG. 2;

FIG. 4 is an exemplary view illustrating an execution process of a battery monitoring apparatus according to an embodiment of the present invention;

FIG. 5 is a flowchart illustrating an execution process of a battery monitoring method according to the present invention; and

FIG. 6 is a view illustrating an embodiment for describing a management measure of the monitoring apparatus according to the present invention.

### DETAILED DESCRIPTION

Hereinafter, exemplary embodiments of the present invention will be described in detail with reference to the accompanying drawings.

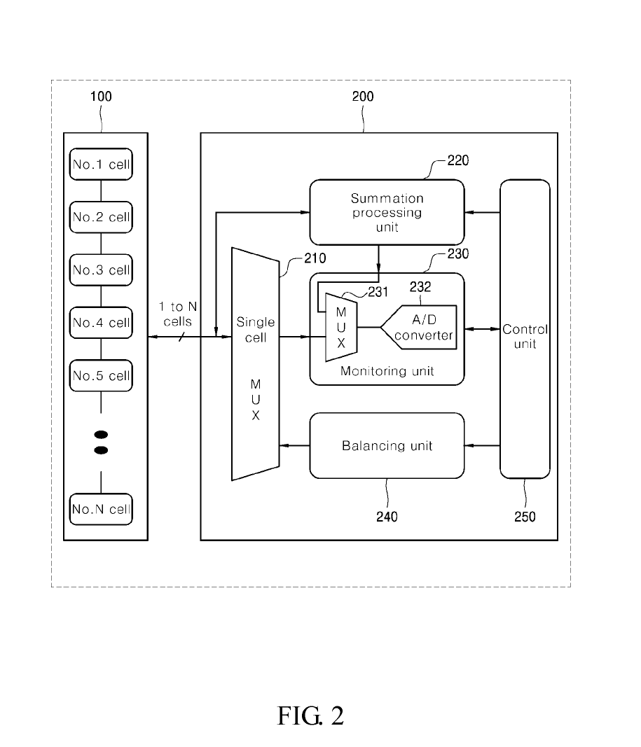

FIG. 2 is a block diagram illustrating a battery monitoring system according to an embodiment of the present invention.

Referring to FIG. 2, the battery monitoring system includes a battery 100 and a battery monitoring apparatus 200.

The battery 100 includes a sub-pack including a plurality of battery cells. For example, the battery 100 may include a sub-pack including N battery cells.

The battery monitoring monitoring apparatus 200 includes a single cell MUX 210, a summation processing unit 220, a monitoring unit 230, a balancing unit 240, and a control unit 250.

The single cell MUX 210 may receive a voltage for a single cell of the battery 100 and provide the received voltage for the monitoring unit 230. For example, the single cell MUX 210 may receive a voltage for No. 1 cell of the battery 100 and provide the received voltage for the monitoring unit 230.

The summation processing unit calculates a voltage for the multiple cells of the battery 100 using the voltage for the single cell of the battery 100 under the control of the control unit 250, and provides the voltage for the multiple cells of the battery 100 for the monitoring unit 230.

In one embodiment, the summation processing unit 220 may calculate a voltage for all the cells of the battery 100 under the control of the control unit 250. For example, when the battery 100 includes eight cells, the summation processing unit 220 may calculate a voltage for the eight cells using the voltages of the Nos. 1 to 8 cells.

In another embodiment, the summation processing unit 220 may calculate a voltage for some cells of the battery 100 under the control of the control unit 250. For example, the summation processing unit 220 may calculate a voltage for Nos. 1 to 4 cells of the eight cells.

The monitoring unit 230 provides any one of a voltage for the single cell of the battery 100 received from the single cell MUX 210 and a voltage for the multiple cells of the battery 100 received from the summation processing unit 220 for the control unit 250, under the control of the control unit 250. The monitoring unit 230 includes a MUX 231 and an A/D converter 232.

The MUX 231 provides any one of a voltage for the single cell of the battery 100 received from the single cell MUX 210 and a voltage for the multiple cells of the battery 100 received from the summation processing unit 220, for the control unit 232.

The A/D converter 232 converts any one of a voltage for a single cell of the battery 100 received from the MUX 231 and a voltage for the multiple cells of the battery 100 into a digital voltage and provides the converted digital voltage to the control unit 250, under the control of the control unit 250.

The balancing unit 240 executes balancing for the cells of the battery 100 under the control of the control unit 250.

The control unit 250 receives a voltage for the multiple cells of the battery 100 from the monitoring unit 230, and identifies a normal state of the battery according to whether the voltage for the multiple cells of the battery 100 falls within a preset reference voltage range.

In one embodiment, if the voltage for the multiple cells of the battery 100 falls within a preset reference voltage range, the control unit 250 may perform a control to stop calculation of the voltage for the corresponding cells.

For example, if the voltage for Nos. 1 to 4 cells is 11 V and the reference voltage range for the cells is 2 V to 3 V, the control unit 250 may perform a control to stop calculation of the voltage for Nos. 1 to 4 cells because the voltage for the four cells falls within 8 V to 12 V corresponding to the reference voltage range.

In another embodiment, if a voltage for the multiple cells of the battery 100 does not fall within the preset reference voltage range, the control unit 250 may control the summation processing unit 220 such that the voltages for some of the multiple cells of the battery may be calculated, respectively.

For example, when a voltage for Nos. 1 to 8 is 26 V and the reference voltage range of the cells is 2 V to 3 V, the voltage for the eight cells does not fall within the reference voltage range of 16 V to 24 V, and accordingly, the control unit 250 may control the summation processing unit 220 such that the voltages of some cells of the eight cells, that is, the voltage for Nos. 1 to 4 cells and the voltage for Nos. 5 to 8 cells are calculated.

In the embodiment of the present invention, if some cells of the battery 100 is single cells, the control unit 250 controls the monitoring unit 230 such that a voltage for a single cell of the battery 100 may be provided.

Thereafter, the control unit 250 receives a voltage for the single cell of the battery 100 from the monitoring unit 230, and identifies a normal state of the battery according to whether the voltage for the single cell of the battery 100 falls within a preset reference voltage range.

In one embodiment, if the voltage for the single cell of the battery 100 falls within a preset reference voltage range, the control unit 250 may perform a control to stop measurement of the voltage for the corresponding cells.

In one embodiment, if the voltage for the single cell of the battery 100 does not fall within a preset reference voltage range, the control unit 250 may control the balancing unit such that balancing of the corresponding cell may be executed.

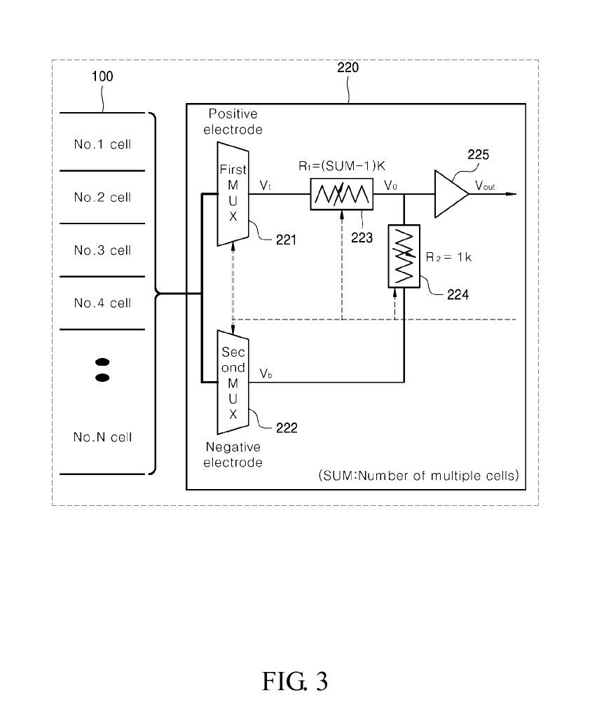

FIG. 3 is a block diagram illustrating an internal structure of a summation processing unit of FIG. 2.

Referring to FIG. 3, the summation processing unit 220 includes a first MUX 221, a second MUX 222, a first resistance distribution module 223, a second resistance distribution module 224, and a level shift amplifier 225.

The first MUX 221 is located at positive electrode terminals of multiple cells in an opposite end input of a single cell for measuring a voltage of a single cell. The first MUX 221 calculates a voltage Vt for the multiple cells of the battery 100 according to a control signal and provides the calculated voltage for the first resistance distribution module 223.

The first MUX 221 may calculate a voltage for all the cells or some cells of the battery 100 according to a control signal and provide the calculated voltage for the first resistance distribution module 223.

The second MUX 222 is located at negative electrode terminals of multiple cells in an opposite end input of a single cell for measuring a voltage of a single cell. The first MUX 222 calculates a voltage Vb for the cells of the battery 100 according to a control signal and provides the calculated voltage for the second resistance distribution module 224.

If receiving the voltage Vt for the cell of the battery 100 from the first MUX 221, the first resistance distribution module 223 lowers the voltage Vt to a voltage in a measurement range of an A/D converter 232 (see FIG. 2) and outputs a voltage Vo. The voltage Vo may be calculated in Equation 1.

$${V}_{o} = \frac{{R}_{2}}{{R}_{1} + {R}_{2}} ( {V}_{t} - {V}_{b} ) + {V}_{b} \qquad Equation 1$$

Vo: Voltage of multiple cells of battery
Vt: Voltage measured with reference to positive electrode terminals of upper ends of multiple cells of battery
Vb: Voltage measured with reference to negative electrode terminals of lower ends of multiple cells of battery
R1: Resistance value for adjusting Vt
R2: Resistance value for adjusting Vb

The voltage Vo calculated in Equation 1 is a value calculated with reference to negative electrode terminals of lower ends of the multiple cells. The voltage Vo is adjusted in Equation 2 for conversion to a digital voltage through the A/D converter 232. The level shift amplifier 225 calculates a voltage for the multiple cells in Equation 2.

Vₒᵤₜ=Vₒ−V_{b} Equation 2
Vout: Voltage for multiple cells of battery
Vo: Voltage calculated in Equation 1
Vb: Voltage that has passed through second resistance distribution module

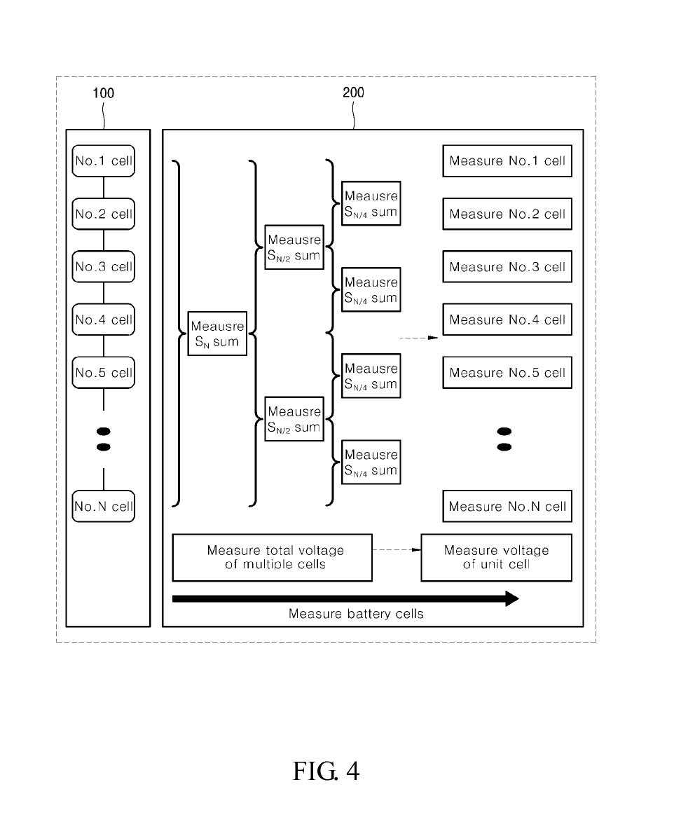

FIG. 4 is an exemplary view illustrating an execution process of a battery monitoring apparatus according to an embodiment of the present invention.

Referring to FIG. 4, the battery monitoring apparatus 200 calculates a voltage for all the cells of the battery 100 using voltages for the cells of the battery 100. As illustrated in FIG. 4, the battery monitoring apparatus 200 calculates a voltage SN for the N cells of the battery 100 using the voltages for Nos. 1 to N cells of the battery 100.

The battery monitoring apparatus 200 determines whether the voltage SN for the N cells of the battery 100 falls within a preset reference voltage range. If the voltage SN for the N cells of the battery 100 does not fall within the preset reference voltage range, the battery monitoring apparatus 200 may calculate a voltage SN/2 for N/2 cells corresponding to a half of the N cells and determine whether the voltage SN/2 for the N/2 cells of the battery 100 falls within the preset reference voltage range.

If the voltage SN/2 for the N/2 cells of the battery 100 does not fall within the preset reference voltage range, the battery monitoring apparatus 200 may calculate a voltage SN/4 for N/4 cells corresponding to a half of the N/2 cells and determine whether the voltage SN/4 for the N/4 cells of the battery 100 falls within the preset reference voltage range.

As described above, the battery monitoring apparatus 200 monitors a state of the battery by calculating the voltage of some cells corresponding to a half of the multiple cells of the battery 100. Because the cells corresponding to a half of the multiple cells becomes a single cell by repeating the above process, the voltages of the single cells may be calculated after the voltage for the multiple cells is completely calculated.

Although the embodiment of FIG. 4 describes a process of monitoring a battery by calculating a voltage of some cells corresponding to a half of the multiple cells for convenience of description, the multiple cells may be divided in different schemes in other embodiments. For example, in another embodiment of the present invention, a voltage for some cells corresponding to one thirds of multiple cells or a voltage for some cells corresponding to one fourths of multiple cells may be calculated.

Furthermore, although the embodiment of FIG. 4 describes a process of calculating a voltage of some cells by sequentially dividing multiple cells for convenience of description, a voltage of some cells that are selected from multiple cells at random may be calculated in another embodiment of the present invention. For example, in another embodiment of the present invention, a voltage of odd-numbered cells of the multiple cells may be calculated and a voltage of even-numbered cells of the multiple cells may be calculated.

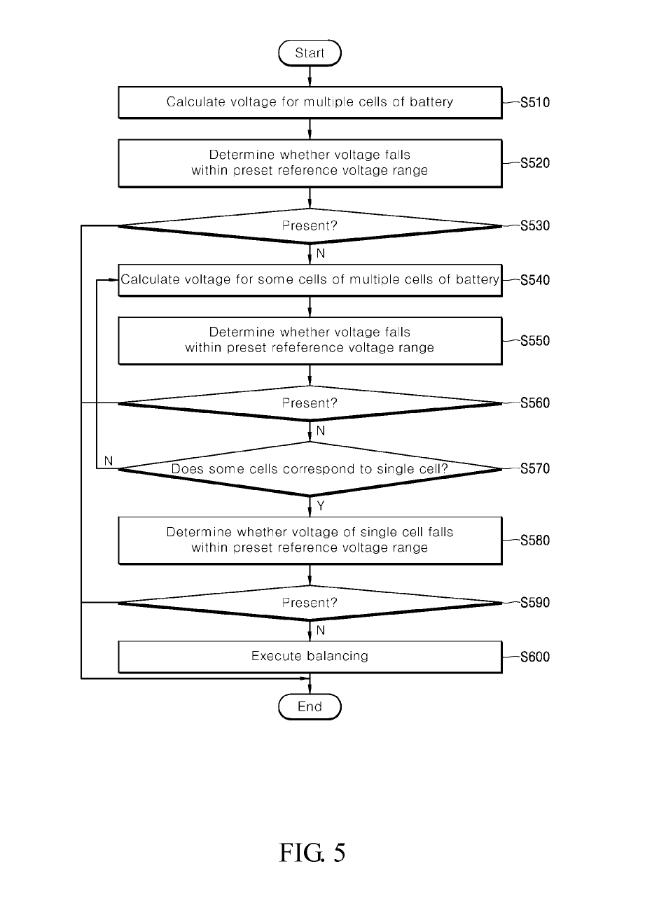

FIG. 5 is a flowchart illustrating an execution process of a battery monitoring method according to the present invention.

Referring to FIG. 5, the battery monitoring apparatus 200 (see FIG. 2) calculates a voltage for multiple cells of the battery (step S510). The battery monitoring apparatus 200 determines whether the voltage for the multiple cells of the battery falls within a preset reference voltage range (step S520). If the voltage for the multiple cells of the battery does not fall within the preset reference voltage range (step S530), the battery monitoring apparatus 200 calculates a voltage for some cells of the multiple cells of the battery (step S540).

The battery monitoring apparatus 200 determines whether the voltage for the some cells of the battery falls within a preset reference voltage range (step S550). If the voltage for the some cells does not fall within the preset reference voltage range (step S560), the battery monitoring apparatus 200 identifies whether the some cells correspond to a single cell (step S570). If the some cells do not correspond to a single cell (step S570), the battery monitoring apparatus 200 returns to step S540 and repeats the above process.

Meanwhile, if the some cells correspond to a single cell, the battery monitoring apparatus 200 identifies whether the voltage for the single cell of the battery falls within the preset reference voltage range (step S580). If the voltage for the single cell does not fall within the preset reference voltage range (step S590), the battery monitoring apparatus 200 performs cell balancing (step S600).

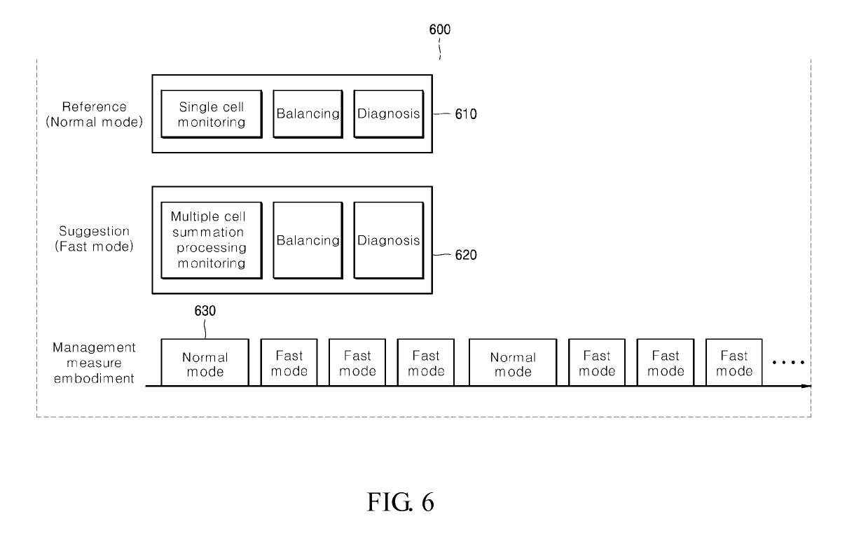

FIG. 6 is a view illustrating an embodiment for describing a management measure of the monitoring apparatus according to the present invention.

Referring to FIG. 6, reference numeral 610b denotes an existing battery monitoring method. As indicted by reference numeral 610, the battery monitoring apparatus sequentially calculates voltages of the cells of the battery to identify whether the calculated voltages fall within ab preset reference voltage range, and executes cell balancing and diagnosis if the voltages of the cells of the battery do not fall within the preset reference voltage range in the identification result.

For example, if the number of cells of the battery is N, the monitoring apparatus calculates a voltage of No. 1 cell of the N cells of the battery, identifies whether the voltage of No. 1 cell falls within a preset reference voltage range, and executes cell balancing and diagnosis according to the identification result.

Thereafter, the monitoring apparatus calculates a voltage of No. 2 cell of the N cells of the battery, identifies whether the voltage of No. 2 cell falls within a preset reference voltage range, and executes cell balancing and diagnosis according to the identification result.

As mentioned above, the battery monitoring unit calculates the voltages of the N cells of the battery, and identifies whether the cells are normal by identifying the voltages of the cells fall within the preset reference voltage range.

Reference numeral 620 denotes a battery monitoring method according to the present invention. As indicated by reference numeral 620, the battery monitoring apparatus calculates a voltage of multiple cells of the battery to identify whether the calculated voltage falls within a preset reference voltage range.

If the voltage of the multiple cells of the battery does not fall within the preset reference voltage range, the battery monitoring apparatus calculates a voltage for some cells of the multiple cells of the battery to identify whether the calculated voltage falls within the reference voltage range.

If the some cells correspond to a single cell, the battery monitoring apparatus identifies whether the voltage for the single cell falls within a preset reference range, and executes cell balancing and diagnosis according to the identification result.

Reference numeral 630 denotes a battery monitoring method in which the existing battery monitoring method of reference numeral 610 and the battery monitoring method according to the present invention of reference numeral 620 are used together. As indicated by reference numeral 630, if the existing battery monitoring method and the battery monitoring method according to the present invention are used together, a detection can be made both promptly and precisely to efficiently perform battery monitoring.

Although the exemplary embodiments of the present invention have been described until now, it is noted that various modifications may be made without departing from the scope of the present invention. Therefore, the scope of the present invention is not limited to the described embodiments, but should be determined by the equivalents of the claims together with the claims.

Although the present invention has been described with reference to the limited embodiments and the drawings, the present invention is not limited to the embodiments, but various corrections and modifications may be made from the description by those skilled in the art to which the present invention pertains. Therefore, the spirit of the present invention should be recognized only by the claims, and their equivalents or equivalent modifications also fall within the scope of the present invention.

What is claimed is:

1. A battery monitoring apparatus comprising:
a summation processing unit that calculates a voltage for multiple cells comprising single cells selected from a plurality of single cells of a battery;
a monitoring unit that monitors at least one of voltages for single cells of the battery and a voltage for the multiple cells of the battery; and
a control unit that identifies whether the battery is normal by using the at least one of the voltages for the single cells of the battery and the voltage for the multiple cells of the battery.

2. The battery monitoring apparatus of claim 1, wherein the control unit determines whether the at least one of the voltages for the single cells of the battery and the voltage for the multiple cells of the battery falls within a preset reference voltage range.

3. The battery monitoring apparatus of claim 2, wherein if the voltage for the multiple cells of the battery does not fall within the preset reference voltage range, the control unit controls the summation processing unit such that a voltage for some cells of the multiple cells of the battery is calculated.

4. The battery monitoring apparatus of claim 2, wherein if the voltage for the multiple cells of the battery falls within the preset reference voltage range, the control unit determines that the corresponding cells are normally operated.

5. The battery monitoring apparatus of claim 3, wherein if the some cells correspond to a single cell, the control unit determines whether a voltage for the single cell of the battery falls within a preset reference voltage range.

6. The battery monitoring apparatus of claim 5, wherein if the voltage for the single cell of the battery does not fall within the preset reference voltage range, the control unit executes balancing for the corresponding cell.

7. The battery monitoring apparatus of claim 1, wherein the monitoring unit comprises:
a MUX that receives at least one of voltages for single cells of the battery and a voltage for the multiple cells of the battery; and
an A/D converter that, if receiving at least one of the voltages of the single cells of the battery and the voltage for the multiple cells of the battery from the MUX, converts the received at least one voltage to a digital voltage and provides the digital voltage for the control unit.

8. The battery monitoring apparatus of claim 1, wherein the summation processing unit comprises:
a first MUX that is located an positive electrode at an upper end of the multiple cells to calculate a first voltage for the multiple cells;
a second MUX that is located an negative electrode at a lower end of the multiple cells to calculate a second voltage for the multiple cells;
a first resistance distribution module that adjusts the first voltage calculated by the first MUX;
a second resistance distribution module that adjusts the second voltage calculated by the second MUX; and
a level shift amplifier that outputs a voltage for multiple cells by using the first voltage received from the first resistance distribution module and the second voltage received from the second resistance distribution module.

9. A battery monitoring method executed by a battery monitoring apparatus that monitors a voltage of a battery, the battery monitoring method comprising:
calculating a voltage for multiple cells of the battery;
determining whether the voltage for the multiple cells falls within a preset reference voltage range; and
identifying whether the battery is normal according to the determination result.

10. The battery monitoring method of claim 9, wherein determining whether the voltage for the multiple cells falls within a preset reference voltage range comprises:
if the voltage for the multiple cells does not fall within the preset reference voltage range, calculating a voltage for some cells of the multiple cells of the battery; and
determining whether the voltage for the some cells falls within a preset reference voltage range.

11. The battery monitoring method of claim 9, wherein determining whether the voltage for the multiple cells falls within a preset reference voltage range comprises:
if the voltage for the multiple cells falls within the preset reference voltage range, determining that the corresponding cells are normally operated.

12. The battery monitoring method of claim 10, wherein calculating a voltage of multiple cells of the battery comprises:
if the some cells correspond to a single cell, determining whether a voltage for the single cell of the battery falls within a preset reference voltage range.

13. The battery monitoring method of claim 12, wherein determining whether the voltage for the single cell of battery falls within a preset reference voltage range comprises:
if the voltage for the single cell of the battery does not fall within the preset reference voltage range, executing balancing for the corresponding cell.
